(19) United States
(12) Patent Application Publication
(10) Pub. No.: US 2002/0172835 A1
(43) Pub. Date: Nov. 21, 2002

(54) Multi-ply panel for a suitcase

(76) Inventor: Chia-Hung Pai, Ta-Chia Chen (TW)

Correspondence Address: DELLETT AND WALTERS, 310 S.W. FOURTH AVENUE, SUITE 1101, PORTLAND, OR, 97204, US

(21) Appl. No.: 09/861,104

(22) Filed: May 18, 2001

(51) Int. Cl. B32B 27/08; B65D 85/18; A45C 13/00

(52) U.S. Cl. 428/518; 428/57; 206/286; 190/125; 190/126

(57) ABSTRACT

A multi-ply panel for a suitcase includes a face ply having at least two pieces of thermoplastic material in different colors and being hot pressed to bond the pieces to each other and form a seam. A hot press medium is arranged in the seam of each of the two pieces of thermoplastic material to connect the pieces more securely. An inner ply has a first side secured on one side of the face ply and a second side. A bottom ply has one side secured on the second side of the inner ply. The means of connecting the pieces of the face ply in the present invention is different from means used in the prior art so that the seam can be straight, curved or wavy to make the face ply looking more vivid and vigorous.

### BACKGROUND OF THE INVENTION

1. Field of the Invention

The present invention relates to a panel for a suitcase, and more particularly to a multi-ply panel that has a face ply formed by at least two pieces of material in different colors.

2. Description of Related Art

A conventional suitcase usually has only one color on the outside surface so that the conventional suitcase does not look particularly distinctive. Consequently, a multi-ply panel was developed to allow the outside surface to be formed from different material. The conventional multi-ply panel for a suitcase in accordance with the prior art comprises a face ply, an inner ply and a bottom ply securely bonded to each other. The face ply is formed from at least two pieces of material in different colors sewn together. The inner ply material is EVA (ethyl vinyl acetate). To manufacture the multi-ply panel, the outside of the face ply is put on the bottom of a cavity of a mold with the seam facing up. Liquid EVA is injected into the mold to form the inner ply and cover the seam. Finally, the bottom ply is bonded to the inner ply to form the multi-ply panel for a suitcase. The face ply of the conventional multi-ply panel can be colorful. However, the multi-ply panel still has several disadvantages that need to be overcome.

1. The sewn pieces of material must to be bent outward so that the seam will be contained in the inner ply after the liquid EVA is injected into the cavity to prevent the seam from showing on the face ply. However, the seam is always a straight line so the face ply will be a plane before the liquid EVA is injected onto the face ply.

2. The sewn pieces of material cannot be bent and still keep the face ply in a plane in the cavity if the seam is a curved. Then the seam can not be contained in the inner ply and the liquid EVA may leak through the needle holes so that the face ply will be rough.

The present invention has arisen to mitigate and/or obviate the disadvantages of the conventional multi-ply panel.

### SUMMARY OF THE INVENTION

The main objective of the present invention is to provide an improved multi-ply panel for a suitcase. The multi-ply in accordance with the present invention includes at least a face ply and an inner ply. The face ply includes at least two pieces of material in different colors. The pieces of material of the face ply are fused by high frequency heating so that the seam can be straight, curved or wavy to make the face ply looking more vivid and vigorous.

Further benefits and advantages of the present invention will become apparent after a careful reading of the detailed description with appropriate reference to the accompanying drawings.

### BRIEF DESCRIPTION OF THE DRAWINGS

FIG. 1 is a cross sectional side plan view of a face ply of a multi-ply panel for a suitcase in accordance with the present invention;

FIG. 2 is a sequence diagram of manufacturing process for the multi-ply panel for a suitcase in accordance with the present invention;

FIG. 3 is a perspective view of the multi-ply panel for a suitcase in accordance with the present invention; and

FIG. 4 is perspective view of another embodiment of the multi-ply panel for a suitcase in accordance with the present invention.

### DETAILED DESCRIPTION OF THE INVENTION

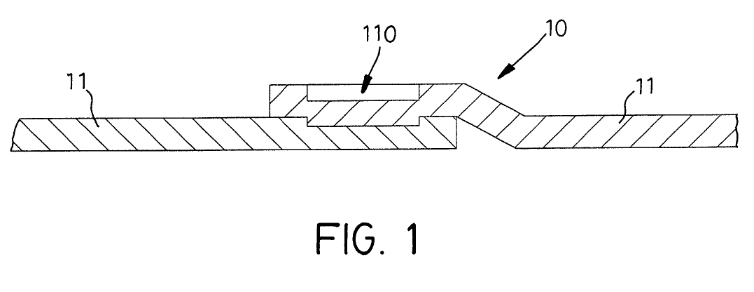

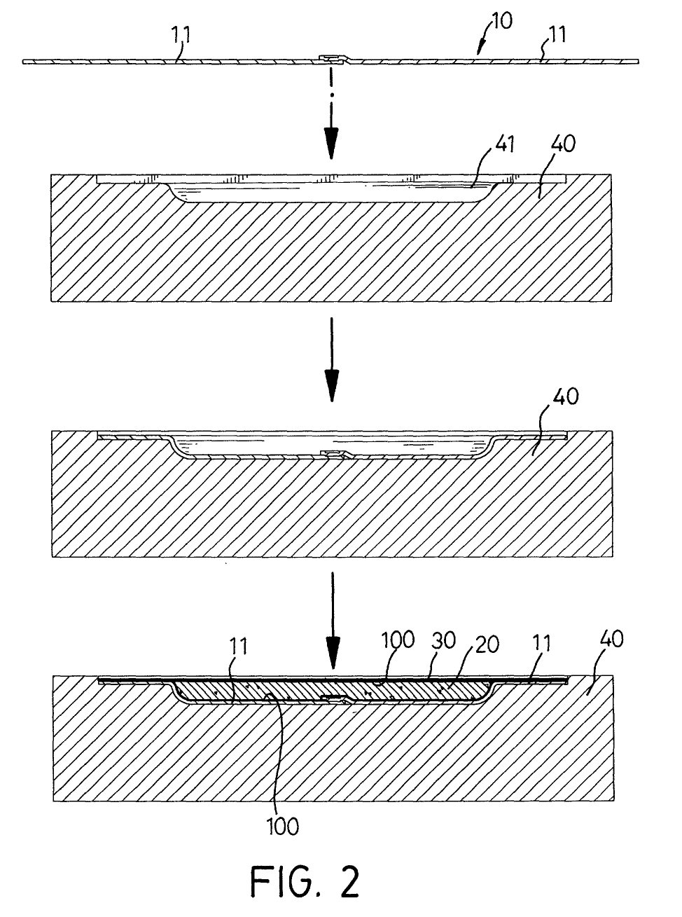

Referring to the drawings and initially to FIGS. 1 and 2, a multi-ply panel for a suitcase in accordance with the present invention comprises a face ply (10), an inner ply (20) and a bottom ply (30) hot pressed to bond to one another. The face ply (10) includes at least two pieces of thermoplastic material (11) fused by high frequency heating to form the face ply (10). Some hot press medium, such as glue, is set in the seam (110) of each piece of thermoplastic material (11) to bond the pieces of thermoplastic material (11) more securely. The thermoplastic material (11) can be selected from material such as PU (polyurethane), polyester, nylon, PVC (polyvinyl chloride) and the like. In the preferred embodiment of the present invention the cover (11) is made of PU. The inner ply (20) is made of EVA (ethyl vinyl acetate). The bottom ply (30) can be cloth made of natural or synthetic fiber. In the preferred embodiment of the present invention the inner ply is made of cloth made of natural fiber.

To make the multi-ply panel, the covers (11) is cut and fused to form the face ply (10). The face (10) is put into a cavity (41) of a mold (40) and the inner ply (20) is injected onto the face ply (10). Lastly, the bottom ply (30) is put on the inner ply (20). The face ply (10), the inner ply (20) and the bottom ply (30) are hot pressed by an upper mold (not shown) and the mold (40) to form the multi-ply panel for a suitcase in accordance with the present invention. To further enhance the bond between the layers, a connecting layer (100) can be placed between the face ply (10) and the inner ply (20), and another connecting layer (100) can be placed between the inner ply (20) and the bottom ply (30). The connecting layer (100) is PE (polyethylene). Where the cost of manufacturing is a factor, PE can be used instead of glue.

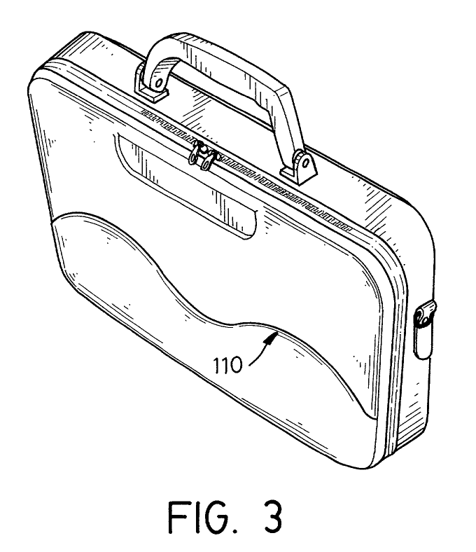

With reference to FIG. 3, the pieces of thermoplastic material (11) of the face ply (10) are fused by high frequency heating so that the seam (110) can be straight, curved or wavy to make the face ply looking more vivid and vigorous.

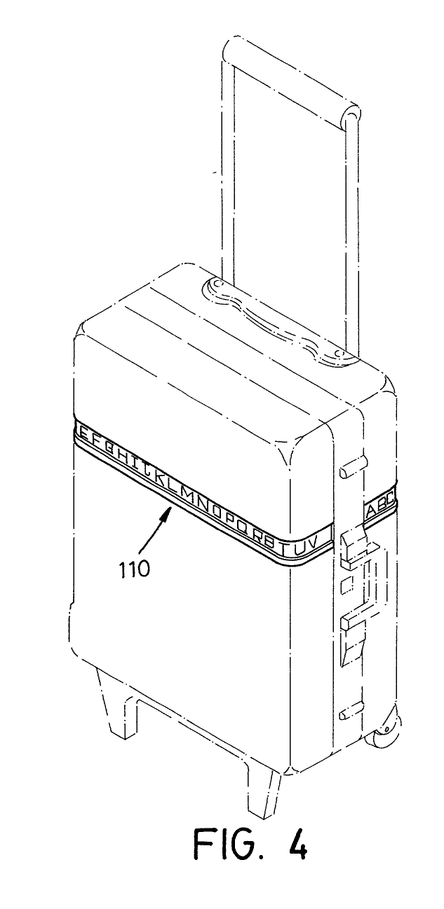

With reference to FIG. 4, the seam (110) can be widened, and characters or patterns can be formed on the face ply (10). Furthermore, the trademark of the suitcase or a company can be shown on a surface of the suitcase via the face ply (10).

Although the invention has been explained in relation to its preferred embodiment, it is to be understood that many other possible modifications and variations can be made without departing from the spirit and scope of the invention as hereinafter claimed.

What is claimed is:

1. A multi-ply panel for a suitcase comprising:
a face ply including at least two pieces of thermoplastic material in different colors being hot pressed to bond the pieces to each other and form a seam, a hot press medium set in the seam of each of the two pieces of thermoplastic material to connect the pieces;
an inner ply having a first side secured on one side of the face ply and a second side; and
a bottom ply having one side secured on the second side of the inner ply.

2. The multi-ply panel for a suitcase as claimed in claim 1, wherein the seam is curved.

3. The multi-ply panel for a suitcase as claimed in claim 1, wherein the hot press medium is polyvinyl chloride.

4. The multi-ply panel for a suitcase as claimed in claim 1, wherein the hot press medium is glue.

5. The multi-ply panel for a suitcase as claimed in claim 1 further comprising two connecting layers respectively arranged among the face ply, the inner ply and the bottom ply to enhance bondage among the face ply, the inner ply and the bottom ply.
